(19) United States
(12) Patent Application Publication
(10) Pub. No.: US 2005/0286189 A1
(43) Pub. Date: Dec. 29, 2005

(54) Method and apparatus for automatic power line configuration

(76) Inventor: Robert P. Rhodes, Lincoln University, PA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 10/879,767

(22) Filed: Jun. 29, 2004

(51) Int. Cl. H02H 3/00

(52) U.S. Cl. 361/62

(57) ABSTRACT

An automatic power line configuration circuit for coupling a power line signal to a load. The power line signal is coupled to a load via a switching network. A line voltage sensing circuit senses the power line signal and generates one or more relay control signals dependent upon the voltage of the power line signal. The relay control signals are used to configure one or more relays in the switching network.

### FIELD

This invention relates generally to the field of electrical power supply. More particularly, this invention relates to a method and apparatus for automatic power line configuration.

### BACKGROUND

Worldwide there is a wide variation in the power line voltage available to operate analytical equipment such as a Gas Chromatograph (GC). Voltages in Japan are nominally 100V and 200V, but low line conditions can be as low as 90V. Other countries use, nominally, 120V, 220V, and up to 240V with a high line condition being as high as 252V.

Analytical equipment with high power requirements operate directly from the primary power for reasons of efficiency. For example, a Gas Chromatograph uses a high power heater element in its oven. In order to accommodate various power line voltages, the unit may be built with a specific heater matched to a given voltage. As a consequence, it is not possible to change the operating voltage without replacing the heater element. Also, the electronic components of the equipment are powered from a transformer that has various primary taps. The appropriate wiring of these taps is accomplished with a configuration plug, which has wires to connect the various taps in parallel or series, as required. To change the operating voltage of the equipment, this plug must be exchanged for one that supports the new desired voltage.

Changing to a new voltage without making the appropriate changes to the equipment could result in damage to the equipment, so the equipment may be protected by various means. The equipment may also be protected from changing voltages.

The need for multiple equipment designs meet various voltage requirements and the need to protect from incorrect voltages adds cost and complexity to the equipment.

### SUMMARY

The present invention relates generally to electrical power supply. The invention relates to an automatic power line configuration circuit for coupling a power line signal to a load. The power line signal is coupled to the load via a switching network. A line voltage sensing circuit senses the power line signal and generates one or more relay control signals dependent upon the voltage of the power line signal. The relay control signals are used to configure one or more relays in the switching network.

### BRIEF DESCRIPTION OF THE DRAWINGS

FIG. 1 is a block diagram of a system including an automatic power line configuration circuit in accordance with an embodiment of the invention.

FIG. 2 is a block diagram of an embodiment of a line voltage sensing circuit in accordance with an embodiment of the invention.

FIG. 3 is a block diagram of an embodiment of a switching network in accordance with an embodiment of the invention.

FIG. 4 is a circuit diagram of an exemplary rectifier, voltage divider and smoothing filter in accordance with an embodiment of the invention.

FIG. 5 is a circuit diagram of an exemplary voltage follower in accordance with an embodiment of the invention.

FIG. 6 is a circuit diagram of an exemplary reference voltage generator and comparator circuit in accordance with an embodiment of the invention.

FIG. 7 is a circuit diagram of exemplary logic, output buffer and monitoring isolator circuits in accordance with an embodiment of the invention.

FIG. 8 is a circuit diagram of an exemplary switching network circuit in accordance with an embodiment of the invention.

FIG. 9 is a first graph showing the performance of an embodiment of the present invention.

FIG. 10 is a second graph showing the performance of an embodiment of the present invention.

FIG. 11 is a third graph showing the performance of an embodiment of the present invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

One embodiment of the present invention relates to an automatic power line configuration circuit that allows analytical equipment to be operated across a range of power line voltages.

A further embodiment of the present invention relates to an automatic power line configuration circuit that allows analytical equipment to be powered directly off a primary power line.

A still further embodiment of the present invention relates to an automatic power line configuration circuit that protects electronics components of analytical equipment from inadvertent line voltage operation.

One embodiment of the automatic power line configuration circuit of the present invention operates to select the power line voltage configuration automatically without intervention by the user. For example, a Gas Chromatograph could be operated at 120V at a first location and then at 240V at a second location without the need for manual reconfiguration. This is convenient to the user. It is also advantageous to the manufacturer of the equipment since a generic machine can be designed and built without reference to specific voltage requirements.

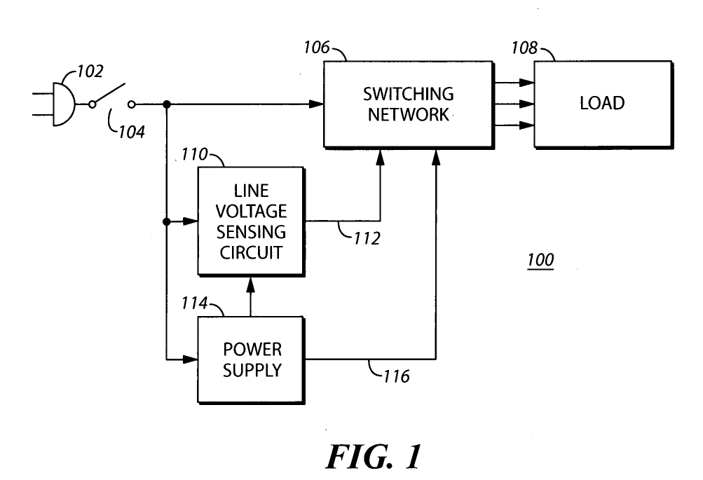

FIG. 1 is a block diagram of system incorporating an automatic power line configuration circuit in accordance with an embodiment of the invention. The automatic power line configuration circuit may be used with a variety of analytical instruments or other equipment. In particular, the automatic power line configuration circuit may be used with a Gas Chromatograph. Referring to FIG. 1, the power line voltage is received at 102. The line voltage then passes through on/off switch 104 to switching network 106. Switching network 106 supplies the power line voltage to the load 108. The load may be various elements of the analytical equipment, such heaters, fan, pumps and transformers. The line voltage is also passed to line voltage sensing circuit 110. The line voltage sensing circuit 110 measures the line voltage and creates several relay control signals 112, which are used to power relays in the switching network 106. The power supply 114 provides low voltage for the operation of the line voltage sensing circuit 110 and provides power for relays in the switching network 106. The power supply 114 is preferably a floating power supply since it references a floating ground.

In one embodiment, the power supply 114 provides a 24V supply used directly to power relays in the switching network 106 and a 5V supply to power the line voltage sensing circuit 110. The power supply may be a commercial off-line switching power supply. Such supplies are available with an input operating range of 90V to 250V.

The relays in the switching network 106 configure series or parallel connections as appropriate to provide the correct voltage to the load 108.

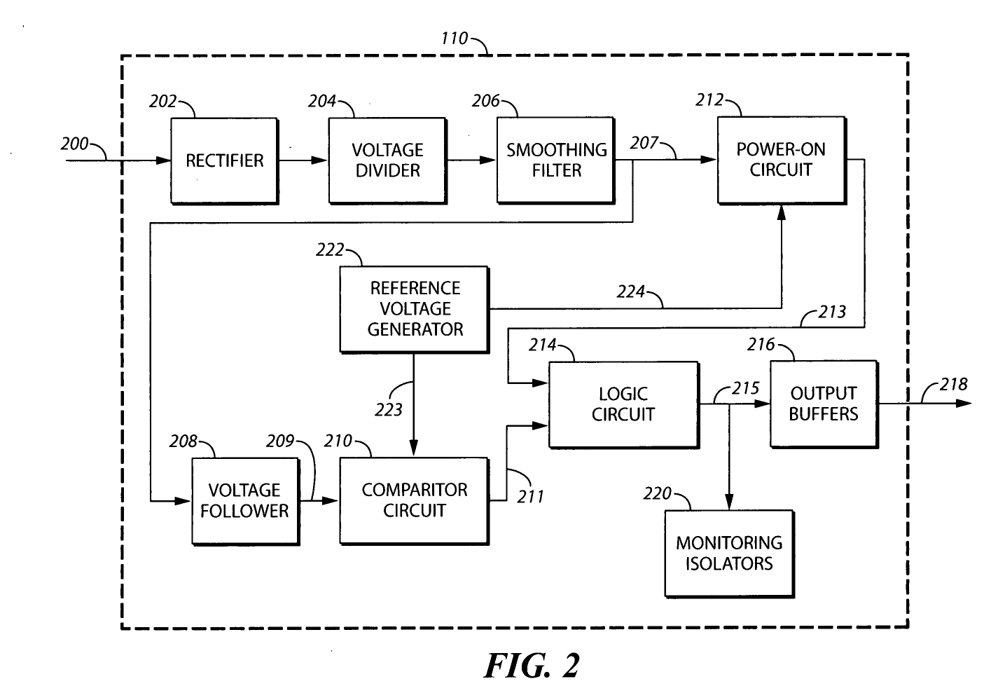

FIG. 2 is a block diagram of a line voltage sensing circuit 110 in accordance with an embodiment of the invention. Referring to FIG. 2, the line voltage sensing circuit 110 receives the line voltage at input 200. The line voltage is rectified in rectifier 202 and dropped to a lower voltage using voltage divider 204 for use in the remainder of the line sensing circuit. The reduced voltage signal from the voltage divider 204 is passed through smoothing filter 206 to provide a smoothed voltage signal 207 proportional to the average voltage of the rectified line voltage. The smoothing filter may also include a voltage limiter.

The output 207 from the filter 206 is passed to voltage follower 208. The voltage follower 208 may be designed to follow rising voltages rapidly but to follow falling voltages more slowly. The output 209 from voltage follower 208 is compared in a comparator circuit 210 to one or more reference voltage levels 223 so as to determine the range the voltage falls into. The reference voltages 223 are supplied by reference voltage generator 222. The outputs 211 from the comparator circuit 210 drive logic circuit 214 to produce signals 215 indicative of the voltage range. The signals 215 are buffered in output buffers 216 to provide relay control signals 218 that are used to drive relays in the switching network. The smoothed voltage signal 207 is also passed to power-on circuit 212 the produces a logic enable signal 213. When power is first applied, the logic enable signal 213 is set to disable the logic circuit 215. In the disabled condition, the logic circuit produces an output 215 appropriate for the highest voltage level. This causes the voltage configuration to be set for the highest voltage and prevents damage to the powered equipment during the start-up transient. After an appropriate delay, the logic enable signal is switched to enable the logic circuit. This allows time for the remainder of the circuit to stabilize and correctly determine the input line voltage. The power-on circuit receives reference signal 224 from the reference voltage generator 222.

Optional monitoring isolators 220 (such as opto-isolators) allow the signals 215 to be monitored (by the main system processor, for example). Isolation is required when the line sensing circuits operates from a floating ground.

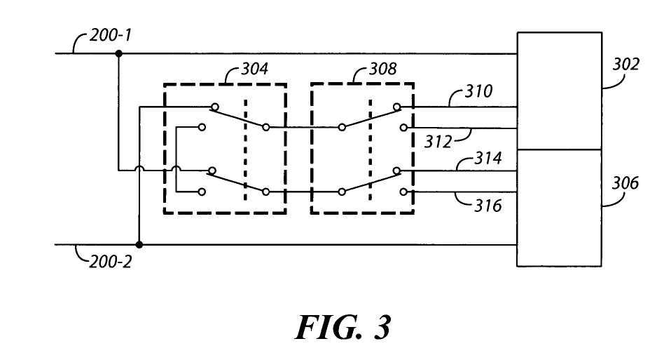

FIG. 3 is a block diagram of an embodiment of an element of switching network in accordance with an embodiment of the invention. Line voltage signals 200-1 and 200-2 (phase and neutral or phase 1 and phase 2) are supplied to the network. Line voltage signal 200-1 is supplied to the first element 302 of a load and to one side of a series/parallel switch 304. Line voltage signal 200-2 is supplied to the second element 306 of the load and to the other side of the series/parallel switch 304. The series/parallel switch 304 is operated by a relay and switches the elements 302 and 306 between a series arrangement and a parallel arrangement. Optionally, switch 308 is included between the series/parallel switch 304 and the load elements 302 and 306. For example, when the load is a transformer, the switch 308 can be operated by a second relay to switch between taps 310 and 312 of the first element of the transformer and between taps 314 and 316 of the second element of the transformer. In some applications, the load element is less sensitive to input voltage and the series/parallel switch 304 is sufficient to configure the voltage supply.

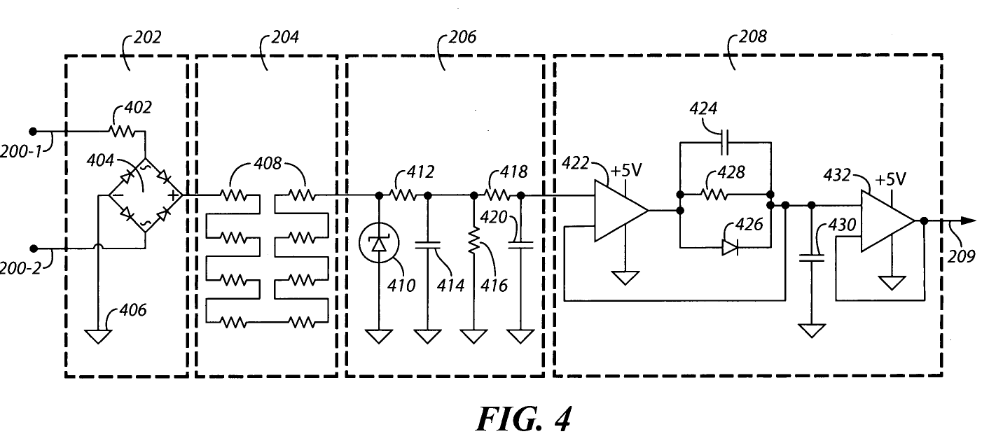

FIG. 4 is a circuit diagram of an exemplary embodiment of a rectifier, voltage divider, smoothing filter and voltage follower of a voltage sensing circuit of the present invention. Referring to FIG. 4, the line voltage signals 200-1 and 200-2 (phase and neutral or phase 1 and phase 2) are received by the rectifier 202. One phase is passed through a resistor 402 to one arm of diode bridge rectifier 404, the phase is directly coupled to the bridge rectifier 404. The resistance 402 couples with stray capacitance of the bridge rectifier to form a smoothing filter that reduces voltage spikes. The bridge rectifier is coupled to a floating ground or common 406. The floating ground moves relative to the one power line phase or the other depending on which two of the diodes in diode bridge 404 are conducting. It is thus important that the capacitive coupling from power line to the floating ground be low so as to avoid distortion in the full-wave rectified signal generated by diode bridge rectifier 404 and the voltage divider 204. Any distortion will cause an error in the measurement of the line voltage. The rectified line voltage output from the rectifier is coupled to the voltage divider 204. The voltage divider 204, which comprises multiple resistors 408 arranged in series, drops the rectified line voltage to a low (and safe) level for the remainder of the sensing circuit. The lowered voltage signal is passed to smoothing filter section 206. The smoothing filter section 206 includes a zener diode 410 that limits the voltage received by the circuit. The resistors 412, 416 and 418 and the capacitors 414 and 420 form a smoothing filter that smoothes the rectified voltage. The output from the smoothing filter section 206 is a smoothed voltage signal proportional to the average of the rectified line voltage.

The smoothed voltage signal is passed to amplifier 422 of the voltage follower 208. For slowly changing line voltages, the voltage on capacitor 430 follows the input to the amplifier 422. If, however, rapid changes occur, such as a dropped line cycle or a voltage surge, the other components come into play. A dropped cycle will cause a sudden drop of the input to the amplifier 422, causing the output of the amplifier to drop to near zero volts. Diode 426 will be reversed biased, and the resistor 428 will slowly discharge capacitor 430. This means that falling voltages will only slowly be recognized at capacitor 430. If a line voltage surge were to occur, the output of the amplifier 422 will rise, but the diode 426 will now conduct and capacitor 430 will be charged. This forces the voltage on capacitor 430 to follow rising voltages rapidly with virtually no lag. Capacitor 424 smoothes the transition between rising to falling or falling to rising voltage as seen by amplifier 422. The voltage on capacitor 430 is buffered by amplifier 432 to provide output voltage 209 that is passed to the comparator circuit. In one embodiment, the output voltage 209 is approximately 1.2% of the RMS value of the line voltage, although a slight offset correction may be needed because of the diode voltage drops from diodes 426.

In one embodiment, multiple resistors are coupled in series to form the voltage divider 204 used in the measurement of the line voltage. This allows small precision surface mount resistors to be used in the divider. For example, when each part has a limited maximum voltage rating of 100V, using 10 parts reduces the voltage across each part to less than 50V at the highest line voltage. This also reduces the power dissipation in each part, giving the most reliable design. Precision, 0.1% parts may be used in the divider to give an accurate measure of the line voltage.

The power line voltage is used directly for the input to the voltage divider 204. If the power line were to be stepped down using a small transformer, several errors could be added to the measurement. The bridge diodes add a temperature dependant offset, and this would be a larger fraction of the lower voltage from the transformer. The transformer could distort the voltage waveform, changing the relationship between the average, which is measured, and the true RMS voltage of the line. Also varying loads on the transformer could affect the measured voltage due to the imperfect coupling of the transformer. These effects are all avoided by using the line voltage directly.

The selection of filter component values requires a balance between the need for the circuit to respond quickly to determine the correct operating range and the need for the circuit to be immune to power line anomalies.

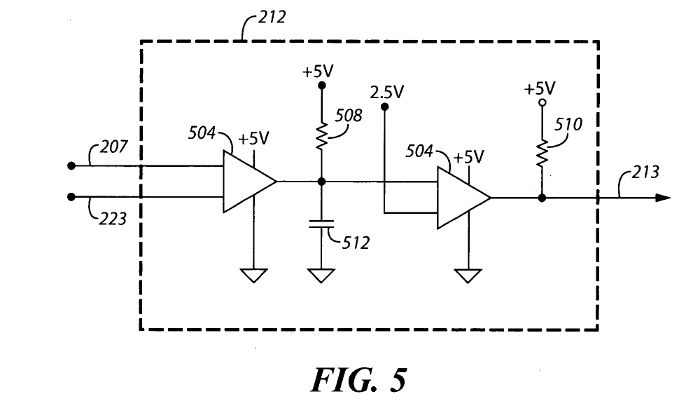

FIG. 5 is a circuit diagram of an exemplary power-on circuit in accordance with an embodiment of the present invention. Referring to FIG. 5, smoothed voltage signal 207 and a reference voltage signal 224 are received as input signals. Components 504 and 506, the associated resistors, 508 and 510, and capacitor 512 form the power-on circuit. Before the circuit is powered, capacitor 512 will be discharged. When power is first applied, the voltage on the input of comparator 504 quickly rises, releasing the output and allowing capacitor 512 to charge through resistor 508. About 2 seconds later, in this exemplary embodiment, the voltage on capacitor 512 reaches 2.5V and the output 514 of comparator 506 switches high. This enables the logic circuit as will be described below. The purpose of this delay is to force the configuration to its highest range, 240V, until the rest of the circuit has had a chance to stabilize and correctly determine the input line voltage. This prevents a rapid turn-on (the normal condition caused by the power switch) from setting the circuit to too low of a range. Note that at power off, the input voltage to comparator 504 falls rapidly, only limited by the 0.2-second time constant of the smoothing filter. This causes comparator 504 to rapidly discharge capacitor 512, resetting the delay time. Rapid On/Off cycles will not allow the configuration to be erroneously set to a low range.

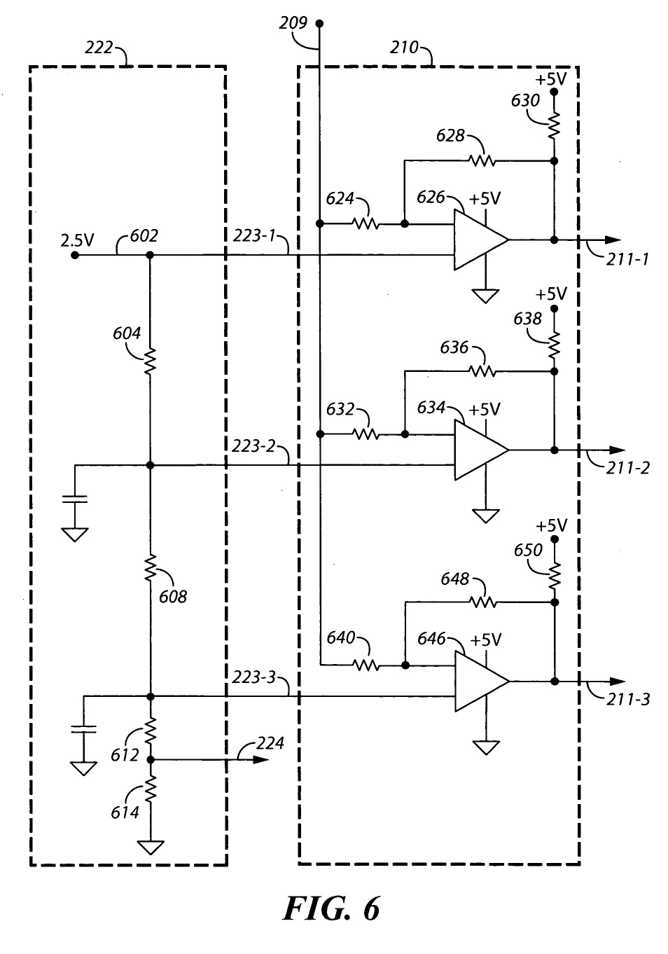

FIG. 6 is a circuit diagram of an exemplary reference voltage generator circuit 222 and a comparator circuit 210 in accordance with an embodiment of the present invention. Referring to FIG. 6, reference voltage generator circuit 222 has a 2.5V reference voltage 602 as input. This is passed directly to output to provide the first reference voltage 223-1. The signal 602 is also passed through a first voltage divider comprising resistor 604 to provide a second reference voltage 223-2. The signal is then passed through a second voltage divider comprising resistor 608 to provide a third reference voltage 223-3. Finally, the signal is passed through series resistors 612 and 614 to ground. This provides reference voltage 224 that is supplied to the power-on circuit described above.

FIG. 6 also shows comparator circuit 210. The comparator circuit 210 receives the signal 209 output from the voltage follower circuit. In this embodiment, the signal 209 is compared with three reference voltage levels. Additional voltage levels may be used in other embodiments to provide higher resolution. In a still further embodiment an analog-to-digital converter may be used to determine the level of the signal 209. Signal 209 is passed through resistor 624 and compared with signal 223-1 in comparator 626. Hysteresis around the comparator 626 is provided by the feedback loop containing resistor 628. This keeps the comparator stable when the signal 209 is slowly changing close the threshold voltage. When the signal 209 exceeds the reference voltage 223-1, the +5V supply is coupled through resistor 630 to the output 211-1. Similarly, comparator 634, together with resistors 632, 636 and 638, compares the signal 209 to the reference voltage 223-2 to produce indicator signal 211-2, while comparator 646, together with resistors 640, 648 and 650, compares the signal 209 to the reference voltage 223-3 to produce indicator signal 211-3.

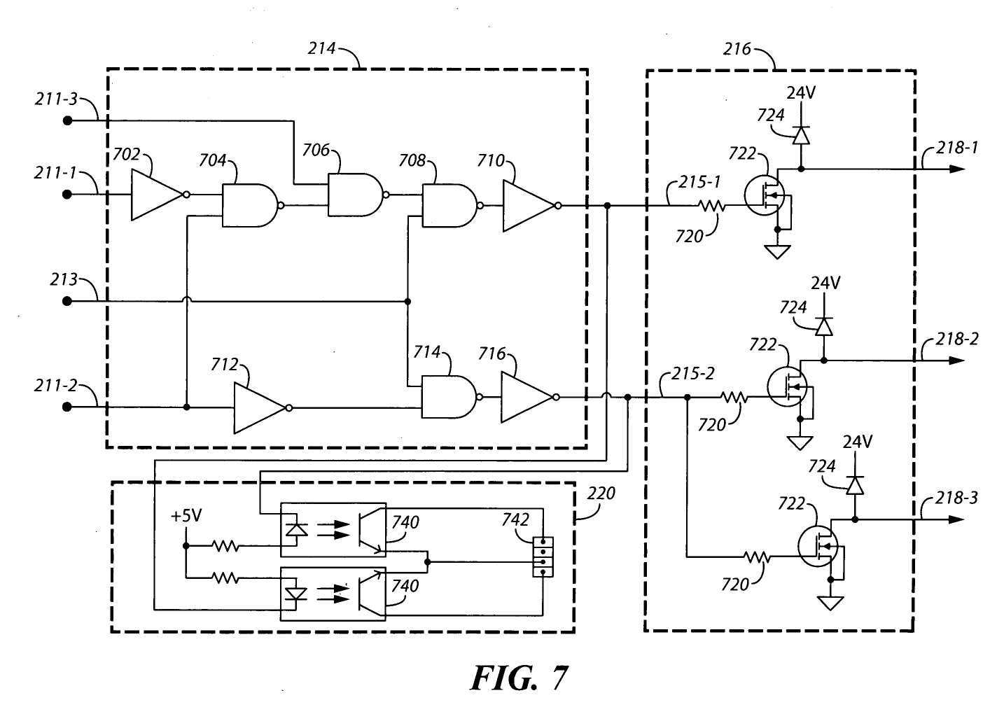

FIG. 7 is a circuit diagram of an exemplary logic circuit 214, output buffer circuit 216 and monitoring circuit 220. The logic circuit 214 receives logic enable signal 213 from the power-on circuit, and outputs 211 from the comparator circuit. In one embodiment, the comparator circuit is configured so that signal 211-3 is asserted when the voltage is greater than 109V, signal 211-2 is asserted when the voltage is greater than 149V, and signal 211-1 is asserted when the voltage is greater than 217V. This is summarized in table 1.

TABLE 1

| Input Voltage | 211-1 | 211-2 | 211-3 |
|---|---|---|---|
| <109 | 0 | 0 | 0 |
| 109-149 | 0 | 0 | 1 |
| 149-217 | 0 | 1 | 1 |
| >217 | 1 | 1 | 1 |

The circuit comprises inverters 702, 710, 712 and 716 together with NAND gates 704, 706, 708 and 714. Each inverter may be implemented as a NAND gate with coupled inputs. Table 2 shows the state of the gate outputs in FIG. 7 for each of the Line Voltage ranges.

TABLE 2

| LineVoltage | 702 | 712 | 704 | 706 | 708 | 714 | 710 | 716 |
|---|---|---|---|---|---|---|---|---|
| <109 | 1 | 1 | 1 | 1 | 0 | 0 | 1 | 1 |
| 109-149 | 1 | 1 | 1 | 0 | 1 | 0 | 0 | 1 |
| 149-217 | 1 | 0 | 0 | 1 | 0 | 1 | 1 | 0 |
| >217 | 0 | 0 | 1 | 0 | 1 | 1 | 0 | 0 |

The last four columns assume that the signal 213 is asserted, which is true after the power has been applied for a while. The final result is that signal 215-1, which is output from inverter gate 710, is high for 100V and 200V line conditions and low for 120V and 240V. Similarly, signal 215-2, which is output from inverter gate 716, is high for line voltage less than 149V and low for line voltages greater than 149V.

The signals 215-1 and 215-2 are passed through resistors 720 and used to drive the output relay buffer transistors 722 in the output buffer circuit 216. Diodes 724 clamp the flyback energy from the relays when they are turned off. Signals 215-1 and 215-2 control the transistor gates to switch the relay control signals 218 to ground (when the relay is ON) or to the supply voltage (when the relay is OFF).

Signals 218 are used to control relays in the switching network or other parts of the analytical equipment.

In this embodiment, the signals 215-1 and 215-2 are also passed to monitoring isolator circuit 220, where they are passed through opto-isolators 740 to terminal connector 742. This allows the signals to be monitored by the main system processor, for example. Isolation is required when the line sensing circuits operates from a floating ground.

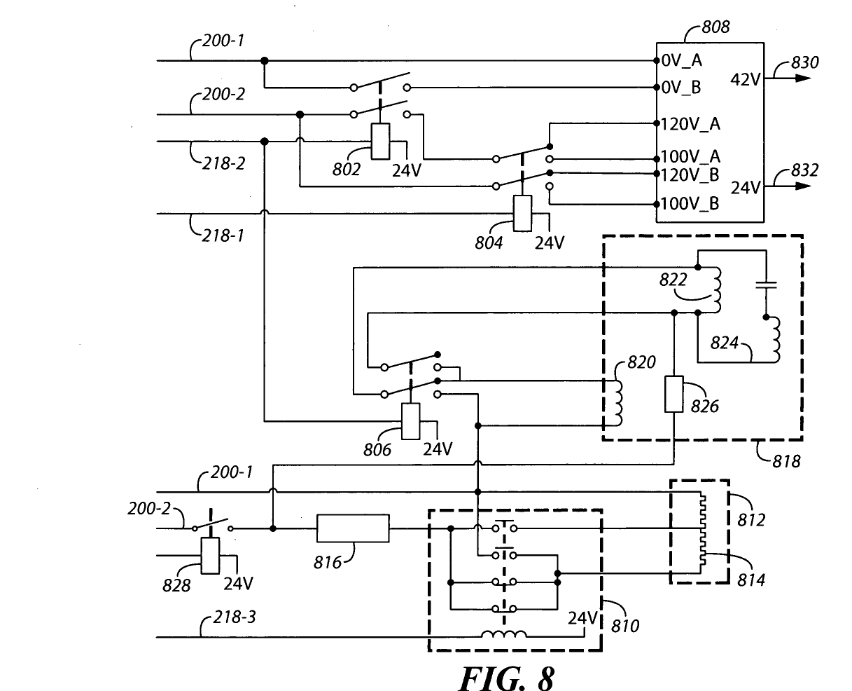

FIG. 8 is a circuit diagram of an exemplary switching network circuit in accordance with an embodiment of the invention. Referring to FIG. 8, the relay control signals 218-1 and 218-2 from the voltage sensing circuit are applied to relays 802, 804 that configure the power supply for transformer load 808. The signal 218-2 is also applied to the relay 806 for the fan motor circuit 818. The relay control signal 218-3 is applied to a double-pole, double-throw (DPDT) relay 810 for the oven heater 812. Consider first the oven heater circuit. The heater 812 is shown as a center-tapped element 814. For operation at high voltages (200V and above), with the relay not energized (as shown in the figure), the center-tap is open, one end of the element is connected to line voltage signal 200-1 and the other end of the element is connected to the line voltage 200-2 through relay 828 and triac 816. The triac 816 controls the heating demand. If the relay control signal 218-3 is asserted, the DPDT relay 810 is energized causing the upper two sets of contacts close and the bottom two open. This connects the lower end of the heater element 814 to the same phase as the top end and connects the center-tap to the triac 816. The two halves of the heater are now in parallel. Other (smaller) variations in line voltage are handled in firmware for the oven heater.

Relay 806 performs a similar function for the oven fan motor 818. Power is supplied to the main motor coils 820 and 822 via thermal cutout 826. Circuit 824, coupled across coil 822 is used for starting the fan in the correct direction. The relay 806 switches the coils 820 and 822 between series and parallel arrangements in response to relay control signal 218-2. No adjustments are needed for smaller variations in line voltage for the motor.

Relays 802 and 804 act together to connect the proper windings of the transformer 808 for operation in each range. The transformer primary has two main windings (winding A and winding B), each accepting 120V end to end. In this embodiment the transformer provides a 42V power output 830 and a 24V power output 832. Each main winding also has a tap at the 100V point (labeled 100V_A and 100V_B in the figure). If relay control signal 218-1 is not asserted, then relay 804 is not energized (as shown in the figure) and the 120V end of each winding is used (labeled 120V_A and 120V_B in the figure). If relay control signal 218-1 is asserted, relay 804 is energized and the 100V taps are used. Relay 802, controlled by relay control signal 218-2, switches between the series or parallel connection of the windings and so switches between the low voltage (˜100V) and the high voltage range (˜200V).

Circuits connected to the power line need to be robust. The power line is a hostile environment with spikes and surges possible as well as dropped cycles and brownout problems. Also, RF energy may be present from outside sources. The circuit of the present invention is designed to be insensitive to all of these anomalies or at least operate in a safe manner. The worst action to take would be for the circuit to be configured as if the unit is operating on 100V or 120V when 240V is actually being applied. This could double the voltage on the transformer output, likely destroying electronics in the unit.

In the event of a failure, the best case would be for the circuit to use the highest voltage setting. In an exemplary embodiment, the de-energized state of the relays sets the 240V range. Failure of the power supply 114 would then cause that range to be used.

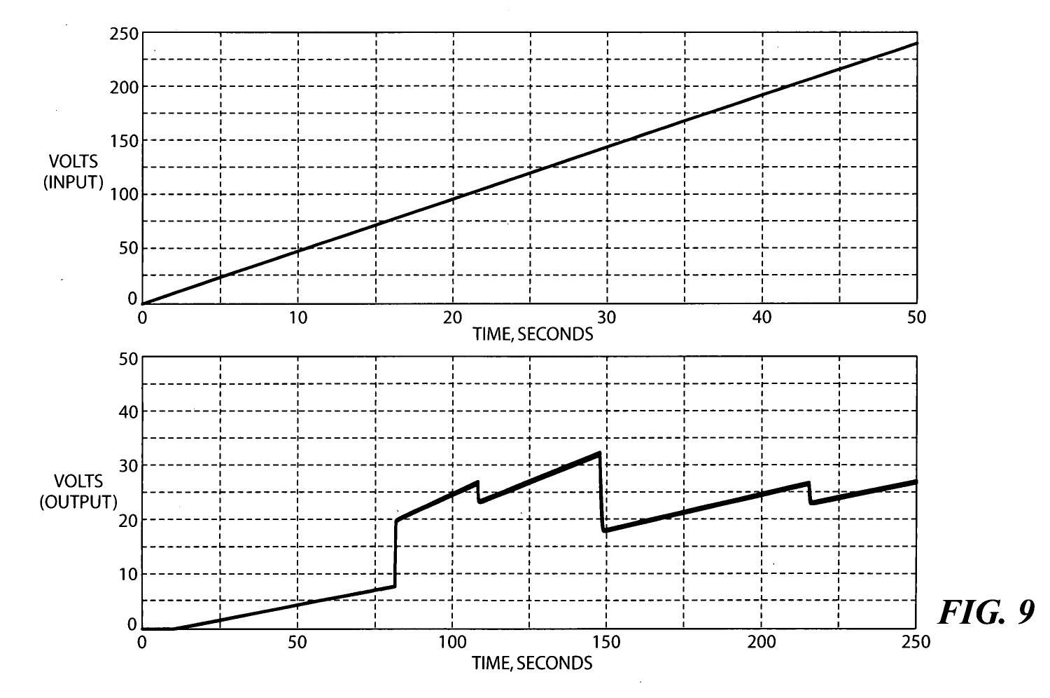

FIGS. 9, 10 and 11 show the performance of a simulation of one embodiment of the power line configuration circuit. Each figure shows two signals. The upper signal is the voltage from the power line, and the second is the voltage of one of the transformer outputs, which has been rectified and filtered. It is nominally about 25 to 26VDC. The figures show the response of that supply to changes in the power line voltage.

FIG. 9 shows a slowly rising line voltage. Below about 80V, the range is set to 240V—all relays de-energized. At 80V the 100V range is used and the transformer output jumps into its expected range of 20V to 34V. When the line reaches about 110V the circuit downshifts to 120V range and the transformer output drops. Similar actions take place at 150V and 220V line voltage. Note that normal line voltages are not used between 132 and 180V. Thus the transformer output would not normally go above about 29V except during brownout recovery as this shows.

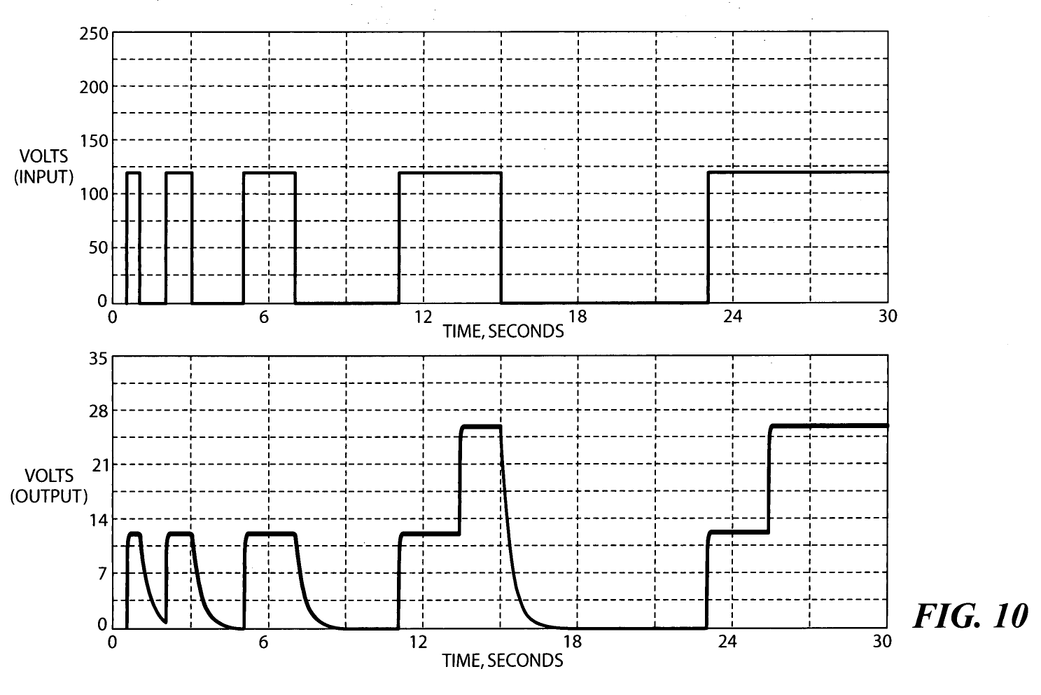

FIG. 10 shows several On/Off power cycles with a 120V line voltage input. The ‘On’ portion of the cycle is increased in steps from 0.5 seconds to 1 second, then 2 seconds, 4 seconds and, finally, ‘On’. The response of the transformer output shows the action of the power-on delay. Until the line has been connected for more than 2 seconds, the circuit operates at 240V range. After 2 seconds, 120V range is used.

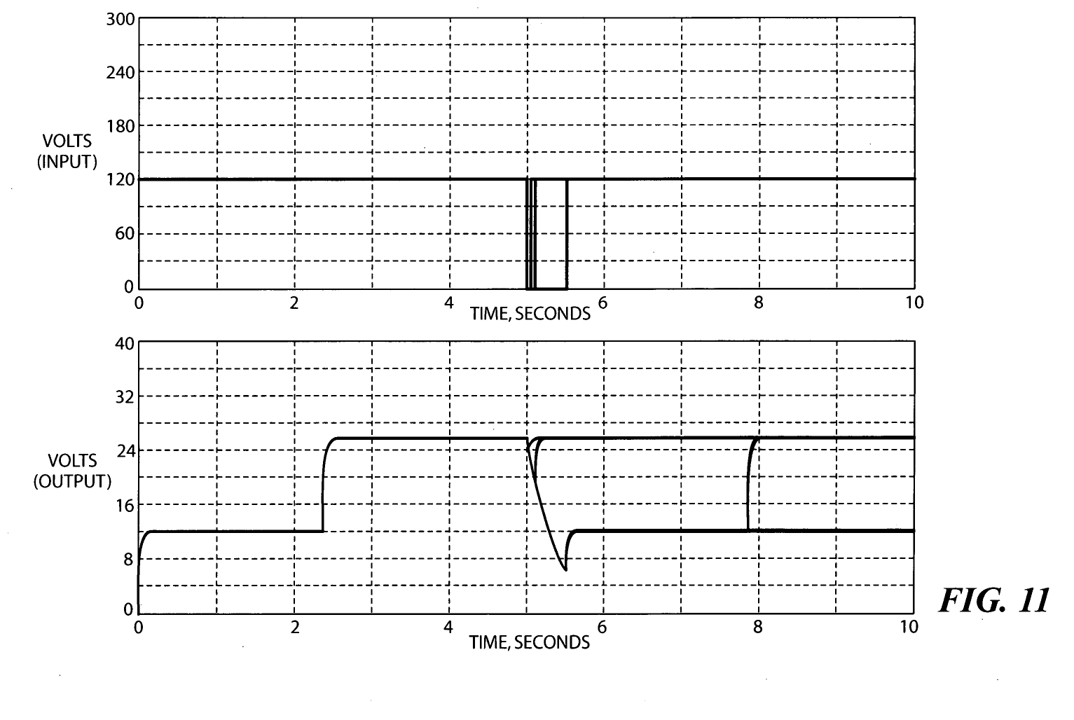

FIG. 11 shows the effect of line dropout. Three conditions are shown, overlapped on the plot. The shortest dropout is just one line cycle or about 0.02 seconds. The transformer output shows a short negative dip. The next dropout is 0.1 seconds and shows a slightly lower dip on the output. The longest dropout is 0.5 seconds and shows that the power-on delay circuit has been activated. The transformer output drops to half its value due to the 240V range being used. Then after about 2 seconds, normal operation is restored. This is one example of the balance needed in the design of the various timing elements.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

1. An automatic power line configuration circuit comprising:
a line voltage sensing circuit, operable to receive a power line signal and to generate one or more relay control signals dependent upon the voltage of the power line signal; and
a switching network comprising one or more relays and operable to provide a connection between the power line signal and a load;
wherein the switching network is configurable in response to the one or more relay control signals.

2. An automatic power line configuration circuit in accordance with claim 1, wherein the load comprises a first load element and a second load element and wherein a relay of the one or more relays of the switching network is operable to connect the first and second load elements in a series arrangement or a parallel arrangement dependent upon a signal of the one or more relay control signals.

3. An automatic power line configuration circuit in accordance with claim 1, wherein the load comprises a transformer element having a first tap position and a second tap position and wherein a relay of the one or more relays of the switching network is operable to connect the power line signal to one of the first and second tap positions dependent upon a signal of the one or more relay control signals.

4. An automatic power line configuration circuit in accordance with claim 1, wherein the voltage sensing circuit comprises:
a rectifier operable to receive the power line signal and produce a rectified power line signal therefrom;
a voltage divider operable to reduce the voltage level of the rectified power line signal;
a smoothing filter operable to receive the reduced level rectified power line signal and produce a smoothed voltage signal;
a comparator circuit operable to compare the smoothed voltage signal to one or more reference voltage signals;
a logic circuit operable to receive one or more output signals from the comparator circuit and produce one or more voltage indicator signals, indicative of the voltage level of the power line signal; and
an output buffer circuit, responsive to the one or more voltage indicator signals and operable to generate the one or more relay control signals.

5. An automatic power line configuration circuit in accordance with claim 4, wherein the voltage sensing circuit further comprises:
a voltage follower circuit operable to receive the smoothed voltage signal and supply to the comparator circuit a voltage signal that follows the smoothed voltage signal,
wherein the output voltage signal of the voltage follower circuit follows rising voltages more rapidly than falling voltages.

6. An automatic power line configuration circuit in accordance with claim 4, wherein the voltage sensing circuit further comprises:
a power-on circuit operable to inhibit the one or more relay control signals until the voltage sensing circuit has stabilized after power is initially applied.

7. An automatic power line configuration circuit in accordance with claim 4, wherein the voltage sensing circuit further comprises:
a monitoring isolator circuit receiving the voltage indicator signals as inputs and operable to allow monitoring of the voltage indicator signals and
a reference voltage generator, operable to generate the one or more reference voltage signals.

8. An automatic power line configuration circuit in accordance with claim 1, wherein the voltage sensing circuit comprises:
a rectifier having first and second inputs, operable to receive a first phase of the power line signal at the first input; and
a resistive element coupled at a one end to the second input of the rectifier and operable to receive a second phase of the power line signal at the other end;
wherein the resistance of the resistive element combines with stray capacitance of the rectifier to form a smoothing filter.

9. An automatic power line configuration circuit in accordance with claim 1, wherein the load is a power transformer.

10. An analytical instrument comprising:
a transformer; operable to receive a power line signal and produce a secondary power supply therefrom;
electronic analysis equipment powered from the secondary power supply;
a line voltage sensing circuit, operable to receive the power line signal and to generate one or more relay control signals dependent upon the voltage of the power line signal; and
a switching network comprising one or more relays and operable to provide a connection between the power line signal and the transformer;
wherein the switching network is configurable in response to the one or more relay control signals.

11. An analytical instrument in accordance with claim 10, wherein the transformer comprises first and second primary windings and wherein the switching network is operable to switch between a series arrangement of the first and second primary windings and a parallel arrangement of the first and second primary windings.

12. An analytical instrument in accordance with claim 10, wherein the primary winding of the transformer has one or more tap positions and wherein the switching network is operable to switch the power line signal between the one or more tap positions.

13. An analytical instrument in accordance with claim 10, further comprising a heater and a fan, wherein the switching network is further operable to provide a connection between the power line signal and the heater and to provide a connection between the power line signal and the fan.

14. An analytical instrument in accordance with claim 10, wherein the line voltage sensing circuit comprises:
a rectifier operable to receive the power line signal and produce a rectified power line signal therefrom;
a voltage divider operable to reduce the voltage level of the rectified power line signal;
a smoothing filter operable to receive the reduced level rectified power line signal and produce a smoothed voltage signal;
a comparator circuit operable to compare the smoothed voltage signal to one or more reference voltage signals;
a logic circuit operable to receive one or more output signals from the comparator circuit and produce one or more voltage indicator signals, indicative of the voltage level of the power line signal; and
an output buffer circuit, responsive to the one or more voltage indicator signals and operable to generate the one or more relay control signals.

15. An analytical instrument in accordance with claim 14, wherein the line voltage sensing circuit further comprises:
a voltage follower circuit operable to receive the smoothed voltage signal and supply to the comparator circuit a voltage signal that follows the smoothed voltage signal,
wherein the output voltage signal of the voltage follower circuit follows rising voltages more rapidly than falling voltages.

16. A method for automatic configuration of a switching network that provides a connection between a power line signal and a load, the method comprising:
sensing the power line signal to determine the voltage level of the power line signal;
generating one or more relay control signals dependent upon the voltage level of the power line signal; and
configuring the switching network by controlling one or more relays in the switching network using the one or more relay control signals..

17. A method for automatic configuration of a switching network in accordance with claim 16, wherein the load comprises a first element and a second element and wherein configuring the switching network comprises:
coupling the first and second elements of the load in a series arrangement if the voltage level of the power line signal is in a first voltage range; and
coupling the first and second elements of the load in a parallel arrangement if the voltage level of the power line signal is in a second voltage range.

18. A method for automatic configuration of a switching network in accordance with claim 16, wherein sensing the power line signal to determine the voltage level of the power line signal comprises:
rectifying the power line signal to obtain a rectified power line signal;
reducing the level of the rectified power line signal to obtain a reduced level signal;
filtering the reduced level signal to obtain a smoothed voltage signal; and
comparing the smoothed voltage signal to one or more reference voltage signals thereby to obtain one or more level indicator signals.

19. A method for automatic configuration of a switching network in accordance with claim 18, wherein sensing the power line signal to determine the voltage level of the power line signal further comprises passing the smoothed voltage signal through a voltage follower, wherein the voltage follower follows a rising voltage more rapidly than a falling voltage.

20. A method for automatic configuration of a switching network in accordance with claim 16, wherein the load comprises a transformer having a plurality of taps and wherein configuring the switching network comprises switching the power line to one or more of the plurality of transformer taps dependent upon the one or more relay control signals.
